(19) United States
(12) Patent Application Publication
(10) Pub. No.: US 2008/0128996 A1
(43) Pub. Date: Jun. 5, 2008

(54) Silicon carbide fiber seal for ceramic matrix composite components

(75) Inventors: Christopher Grace, Simpsonville, SC (US); Mark Stewart Schroder, Hendersonville, NC (US); Paul Stephen Dimascio, Greer, SC (US)

Correspondence Address: NIXON & VANDERHYE, PC, 901 NORTH GLEBE ROAD, 11TH FLOOR, ARLINGTON, VA, 22203, US

(73) Assignee: General Electric Company, Schenectady, NY (US)

(21) Appl. No.: 12/010,801

(22) Filed: Jan. 30, 2008

Related U.S. Application Data
(63) Continuation of application No. 11/374,071, filed on Mar. 14, 2006.
Application No. 11/374,071 is a continuation of application No. 10/801,002, filed on Mar. 16, 2004, now abandoned.

(51) Int. Cl. F16J 15/44

(52) U.S. Cl. 277/355

(57) ABSTRACT

A silicon carbide fiber brush seal, suitable for use with SiC—SiC CMC components. The seal may be coated with a boron nitride based coating.

The present invention relates to a sealing device for preventing entry of deleterious gas into secondary cavities within a gas turbine. The sealing device can also be used to prevent precious coolant flow from leaking into the gas path or adjacent undesired secondary gas turbine cavities.

### BACKGROUND OF THE INVENTION

It is well known that sealing of hot gases and coolant flow is critical to the operational efficiency of turbo machinery. High temperature, high pressure hot gasses can enter regions of turbo machinery that cannot withstand the temperature regime associated with hot gases, resulting in deleterious effects on turbo machinery performance.

A need exists for an oxidation resistance coating to be applied to the surface of the SiC bristles since they are susceptible to erosion when exposed to deleterious combustion gases found in turbo machinery. There are two known methods for applying a coating to SiC fibers. The first is CVI (Chemical Vapor Infiltration) of a Boron Nitride based coating that is applied in a vacuum furnace in the final configuration shapes shown in attached Figures. The second is CVD (Chemical Vapor Deposition) which is applied in a plasma state deposition of the Boron Nitride based coating on individual fiber tows which are then formed into the seals shown in the attached Figures.

A need exists for a way of sealing hot gas and/or coolant flow from entering or leaving secondary flow cavities in and around ceramic matrix composite components, for example melt-infiltrated ceramic matrix composite components used in turbo machinery. The present invention seeks to meet that need.

### BRIEF DESCRIPTION OF THE INVENTION

It has now been discovered surprisingly that it is possible to provide a sealing device for sealing hot gas and/or coolant flow from entering or leaving secondary flow cavities in and around ceramic matrix composite (CMC) components, for example melt-infiltrated ceramic matrix composite (MI-CMC) components used in turbo machinery. MI-CMC's are high temperature multi-infiltrated matrix of Silicon Carbon in a structured finger lay-up of weave made of Silicon Carbon Fibers in a component shape. In particular, the present invention applies the brush seal concept to ceramic matrix composites by using a new brush material (coated and/or uncoated SiC fibers).

In one aspect, the present invention provides a brush seal made of silicon carbide fibers which may be coated with an oxidation-resistant boron nitride coating. The seal is suitable for use for example with CMC components, more typically with SiC—SiC MI-CMC's.

The need for a new material (SiC fiber) to seal against components made of this new material (MI-CMC) results from the fact there is an extreme degradation mechanism that exists between MI-CMC material and all metals. Due to the presence of corrosive combustive gases being present (in and around) silicon carbide CMC components, there is a rapid ionic transfer with all metallic components that results in a continuous erosion of the silicon carbide CMC component. As such, an alternative brush material (SiC instead of metal) of similar temperature capability as the CMC component needs to be utilized to mitigate this erosion when using a brush seal design

The SiC fibers used in the seal described in the present invention may be in any one of several different forms. Fiber tow, woven fabric, and braided strand are examples of likely forms.

### BRIEF DESCRIPTION OF THE DRAWINGS

FIG. 1 shows a mounting structure for a Stage 1 turbine shroud component;

FIG. 2 shows a seal arrangement in which silicon carbide fibers (coated or uncoated) are attached to a damper block by a metallic component;

FIG. 3 shows an alternative seal arrangement;

FIG. 4 shows another seal arrangement;

FIG. 5 shows a further seal arrangement.

### DETAILED DESCRIPTION OF THE INVENTION

In the following discussion reference will be made to MI-CMC's. However, the present invention is not limited to melt-infiltration CMC's, and is applicable to all CMC's, regardless of their processing.

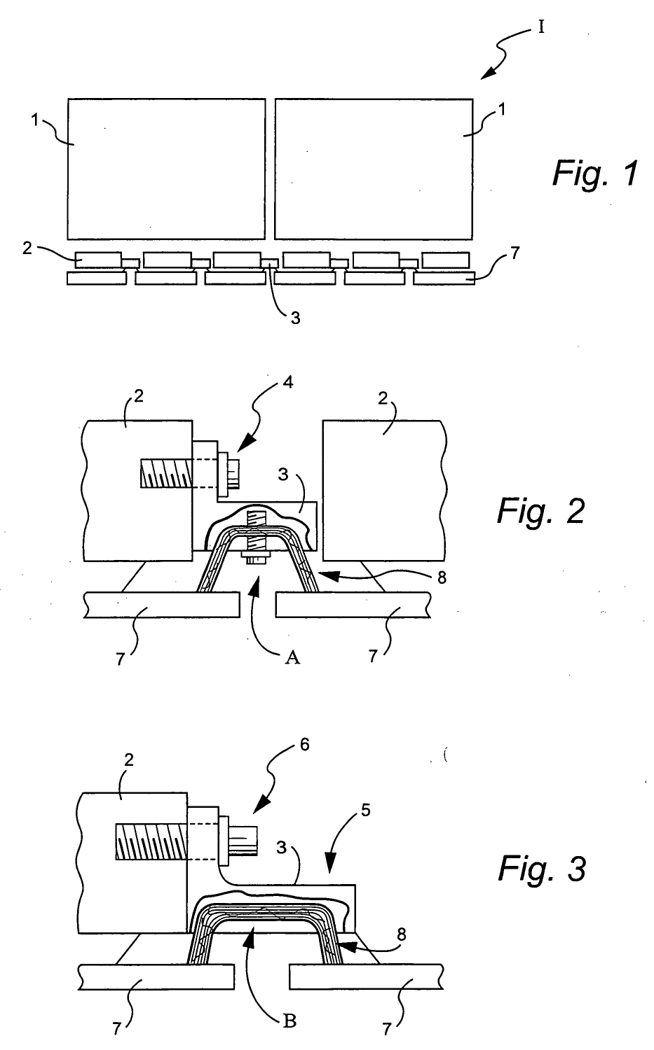

Referring to the drawings, FIG. 1 shows generally the sealing concept of the invention, with four options for seal attachment (described in more detail in FIGS. 2, 3, 4 and 5). In FIG. 1, a metallic mounting structure I is shown for a stage 1 Turbine Shroud component. Attached to outer shroud (1) is a damper block 2 which acts as a loading feature, as well as a gas path pressure pulse damping mechanism onto the inner shroud component 7 that is made of MI-CMC material.

FIG. 2 shows the silicon carbide fibers (coated or uncoated) 8 attached to the damper block 2 by a metallic seal attachment device 3 using a bolt 4 that is threaded and retained (typically by staking) onto the seal attachment 3 device. Another high temperature bolt (A) mechanically retains the fiber seal 8 into the seal attachment device 3. The over-arch of the fiber seal 8 between adjacent inner shrouds 7 prevents the gas turbine hot gases that are flowing between the inner shroud 7 from entering the cavity behind the inner shroud 7 and thus the lower temperature capable metal components (1, 2, 3, 4).

FIG. 3 shows an alternative seal attachment mechanism 5. This alternative is a bonded approach, which chemically bonds the SiC fibers seal 8 into the seal attachment 5, which is then mechanically attached to the damper block 2 using a bolt 6 similar to that shown in FIG. 2. The seal attachment device 5 could be made from monolithic ceramic or another block of MI-CMC using minimal fibers. The seal 8 could be bonded into the attached device 5 in situ or by using any interface block B.

FIG. 4 is the same as FIG. 3 except for using dissimilar material for the interface block C and the attachment device 5 which could be metal or another appropriate material.

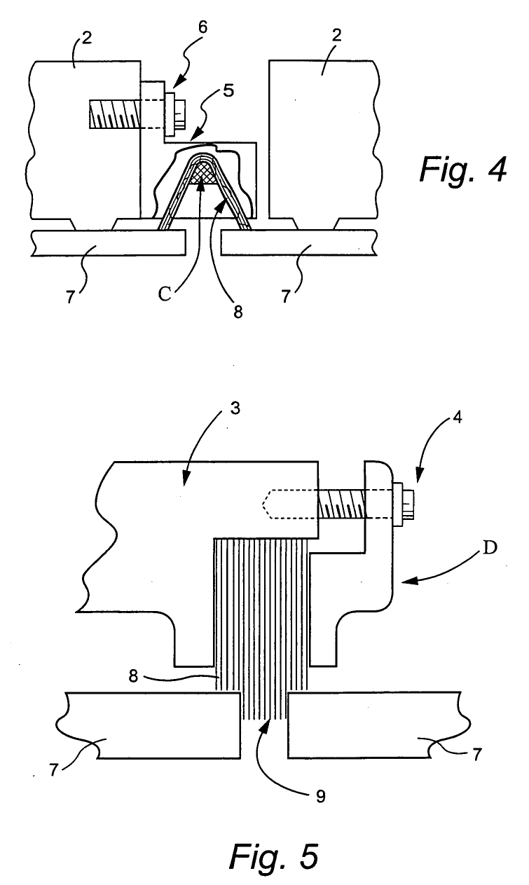

The embodiment of FIG. 5 uses a different approach for the fiber seal 8 attached to the seal attachment device 3. This approach is very similar to conventional metal brush seal design where the bristles 8 are mechanically pressed and retained by a seal holder D and a bolt 4 into the seal attachment device 3. The unique aspect of this embodiment in FIG. 5 uses SiC fibers 8 to not only touch the inner shroud 7 on the backside, but also in between the adjacent shrouds. This further reduces the amount of hot gases that can bypass the turbine bucket and go down the area between adjacent shrouds 7. This helps to improve gas turbine efficiency.

The sealing mechanism described in this patent utilizes oxidation resistive coated silicon carbide (SiC) fibers to prevent hot gas ingestion or cooling air leakage into undesirable locations within turbo machinery. It is especially designed to be compatible with SiC—SiC MI-CMC composite components when used in turbo machinery, bit may be employed with other MI-CMC composites which are not melt infiltrated. The basic operation of the seal is the same as conventional metallic brush seals. The unique feature of the present invention is the material compatibility of SiC fibers sealing against the SiC matrix surface of the MI-CMC components. In addition, the method of manufacturing these SiC fibers into a mounting structure is unique due to material capability (SiC versus metal) of the fibrous seal, the CMC component-sealing surface and the seal mechanism mounting structure.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A silicon carbide fiber brush seal, suitable for use with CMC components

2. A silicon carbide fiber brush seal, suitable for use with SiC—SiC MI-CMC components

3. Brush seal according to claim 1, coated with a boron nitride based coating.

4. Brush seal according to claim 1, wherein said silicon carbide is in the form of fiber tow.

5. Brush seal according to claim 1 wherein said silicon carbide is in the form of woven fabric.

6. Brush seal according to claim 1 wherein said silicon carbide is in the form of braided strand.
